(19) United States
(12) Patent Application Publication
(10) Pub. No.: US 2007/0255571 A1
(43) Pub. Date: Nov. 1, 2007

(54) Method and device for displaying image in wireless terminal

(75) Inventors: Dong-Hoon Noh, Gumi-si (KR); Hwan-Gee Jang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/506,920

(22) Filed: Aug. 21, 2006

(30) Foreign Application Priority Data
Apr. 28, 2006 (KR) 2006-38720

(51) Int. Cl. G10L 21/00

(52) U.S. Cl. 704/275

(57) ABSTRACT

Disclosed is a mobile terminal and method for displaying an image including receiving a voice input from a user in a voice recognition mode, retrieving an image stored with a filename corresponding to the input voice and displaying the retrieved image in a preset format.

### CROSS-REFERENCE TO RELATED APPLICATIONS

This application claims the benefit under 35 U.S.C. §119(a) of Korean Patent Application No. 2006-38720 filed on Apr. 28, 2006 in the Korean Intellectual Property Office, the entire disclosure of which is hereby incorporated by reference.

### BACKGROUND OF THE INVENTION

1. Field of the Invention

The present invention relates to a wireless terminal. More particularly, the present invention relates to a device and a method for displaying an image using voice recognition in a wireless terminal.

2. Description of the Related Art

Additional functions are currently being implemented in wireless terminals. One such function is a high-pixel camera, provided so that image photography is possible without the need for a separate camera. Furthermore, a high-capacity memory may be provided in a wireless terminal so that the photographed images may be stored. The high-capacity memory can also store various musical data for listening. However, in order to retrieve a large amount of data, there is the problem of entering a corresponding menu and sequentially retrieving data that has been previously stored. Such data retrieval is time consuming.

Accordingly, there is a need for an improved mobile terminal and method for retrieving and displaying images.

### SUMMARY OF THE INVENTION

Exemplary embodiments of the present invention address at least the above problems and/or disadvantages and provide at least the advantages described below. Accordingly, it is an object of the present invention to provide a device and a method for facilitating the retrieval of an image and variously displaying the retrieved image in a wireless terminal.

In order to accomplish this object of the present invention, according to an exemplary aspect of the present invention, there is provided a method for displaying an image in a wireless terminal, which includes receiving a voice input, retrieving an image and displaying the retrieved image.

In order to accomplish this object of the present invention, according to another exemplary aspect of the present invention, there is provided a device for displaying an image in a wireless terminal, which includes a voice recognizer for analyzing a voice input through a microphone and outputting the analyzed voice to a controller, a memory for storing an image and an image display format set by a user, a display for displaying the image stored in the memory in accordance with the format set by the user and a controller for retrieving an image stored with a filename corresponding to the voice analyzed in the voice recognizer and controlling the image to be displayed in a preset format.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an exemplary a wireless terminal of the present invention;

FIG. 2 is a flowchart illustrating an operation of setting an image display according to an exemplary embodiment of the present invention;

FIG. 3 is a flowchart illustrating an operation of displaying an image according to an exemplary embodiment of the present invention;

FIG. 4 is a flowchart illustrating an operation of executing a menu in the operation of displaying an image according to an exemplary embodiment of the present invention; and

FIG. 5 is a view illustrating exemplary screens displayed according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, exemplary embodiments of the present invention will be described in detail with reference to the accompanying drawings.

In this exemplary embodiment of the present invention, an operation mode is described wherein an image is displayed using voice recognition which is defined as a voice recognition image viewer mode.

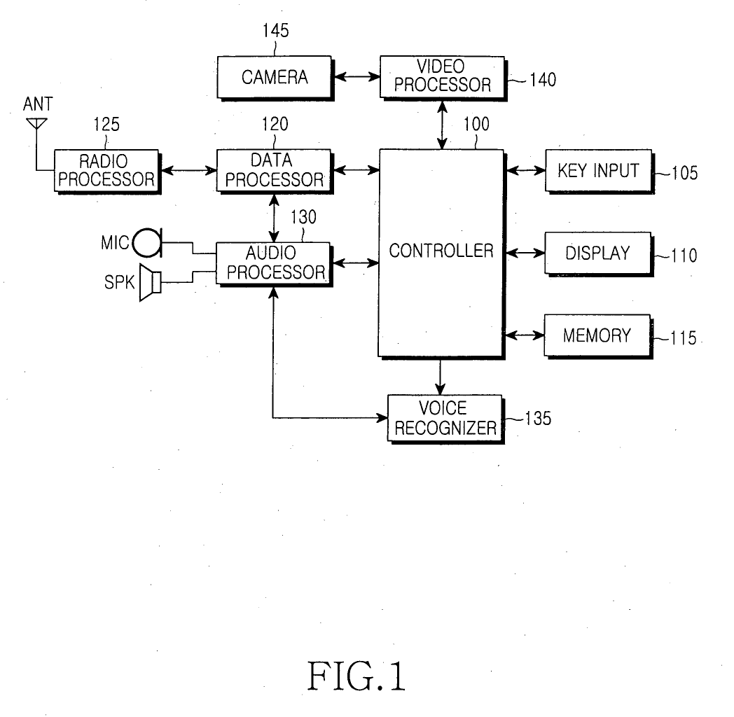

FIG. 1 is a block diagram showing a configuration of an exemplary wireless terminal of the present invention. Referring to FIG. 1, a controller 100 performs a function of controlling a general operation of the wireless terminal. For displaying an image using voice recognition, according to an exemplary embodiment of the present invention, the controller 100 receives input regarding a display format of the image or the like, and stores the input in a memory 115. However, the display format of the image need not be stored prior to receiving voice input and is not necessary to enable performance of the voice recognition mode. The controller 100 senses a menu or key input for executing a voice recognition viewer mode on a user's demand. In the voice recognition viewer mode, the terminal receives a voice input. Accordingly, in the case where a voice is input through a microphone connected to an audio processor 130, the controller 100 performs a function of retrieving an image associated with the voice input. In an exemplary embodiment, the image is stored with a filename corresponding to the voice input in a memory 115. The controller 100 controls the retrieved image to be displayed on a display 110. In an exemplary embodiment, the image is displayed in accordance with a format having been previously set by the user. In an exemplary embodiment, the controller may sense a certain menu input while an image is displayed on the display 110, and perform a function of retrieving a telephone number stored with the filename of the image in the memory 115. The controller 100 controls the function of a menu input from the user to be performed in accordance with a result retrieved from the memory 115. The menu input may include call sending, message sending, picture sending and the like.

A key input 105 includes keys for inputting number and character information and function keys for setting various kinds of functions. The key input 105 according to an exemplary embodiment of the present invention may include a voice recognition mode key for executing voice recognition image viewer mode. When a voice recognition image viewer mode is executed, a display format of an image may be input or chosen through the key input 105.

The display 110 may display a present status of the terminal. The display 110 may also display each processing and operating status depending on a key input from the key input 105 to the controller 100. Further, the display 100 may display image data output from a video processor 140 and a user interface through which a photography function is performed. Here, the display 110 may comprise an LCD and in that case, the display 110 may further include an LCD controller, a memory in which image data can be stored, an LCD element and the like. In a case where the LCD is implemented in a touch-screen mode, the key input 105 and the LCD may constitute alternative, complementary or redundant input units. The display 110 according to an exemplary embodiment of the present invention performs a function of setting an environment for voice recognition image viewer execution and displaying a progress status in accordance therewith. The display 110 may perform a function of sequentially displaying a corresponding image in accordance with a time interval depending on a voice input from a user. Alternatively, the display 110 may display an image in any of a number of formats. For example, the display 110 may be display a plurality of images as a thumbnail format, may display an image in a PIP (Picture-In-Picture) format, may sequentially display an image depending on a key input signal from the key input 105, and the like.

The memory 115 may store a program for execution in the controller 100. The memory 115 may also store data processed by means of the program. Further, the memory 115 may store various kinds of ring tones, MP3s, moving images and the like, which can be output in the wireless terminal. Such a memory 115 may include a read only memory (ROM) in which an operating program is stored, an electrically erasable ROM (EEPROM) that is electrically programmable, a random access memory (RAM) and the like. The memory 115, according to an exemplary embodiment of the present invention, may perform a function of storing an image received from a radio processor 125, an image photographed from a camera 145, and the like. Further, the memory 115 has a program for executing a voice recognition image viewer stored therein. The memory 115 may perform a function of outputting a corresponding image to the display 110 in accordance with the voice recognition image viewer mode. In a case where a menu input is made so as to execute a call or send a message to a telephone number corresponding to the image, the memory 115 performs a function of retrieving the corresponding telephone number so it may be output.

A data processor 120 includes a transmitter for encoding and modulating a transmitted signal, a receiver for decoding and demodulating a received signal, and the like.

The radio processor 125 performs the communications of a wireless terminal. The radio processor 125 includes an RF transmitter for upwardly converting and amplifying the frequency of a transmitted signal, an RF receiver for low noise amplifying a received signal and downwardly converting its frequency. The radio processor 125, according to an exemplary embodiment of the present invention, performs a function of receiving an image from the outside.

The audio processor 130 may constitute a codec, and the codec may include a data codec for processing packet data, an audio codec for processing an audio signal such as a voice, and the like. The audio processor 130 performs a function of converting a digital audio signal received from the data processor 120 into an analog signal through the audio codec so as to reproduce it, or converting an analog audio signal generated and transmitted from a microphone into a digital audio signal through the audio codec so as to output it to the data processor 120.

A voice recognizer 135 performs a function of sensing a user's voice input through a microphone connected to the audio processor 130 and extracting specific data, for example the filename of an image in this exemplary embodiment of the present invention, which is contained in the voice, in a case where the voice recognizer senses a voice or sound at a specific level or more. Further, the voice recognizer 135 retrieves voice data with the highest similarity from data registered in a database of the voice recognizer 135 so as to output the corresponding data to the controller 100. The database of the voice recognizer 135 may be provided inside the voice recognizer 135 or included in the memory 115. Further, the voice recognizer 135 may be separately provided or included in the controller 100.

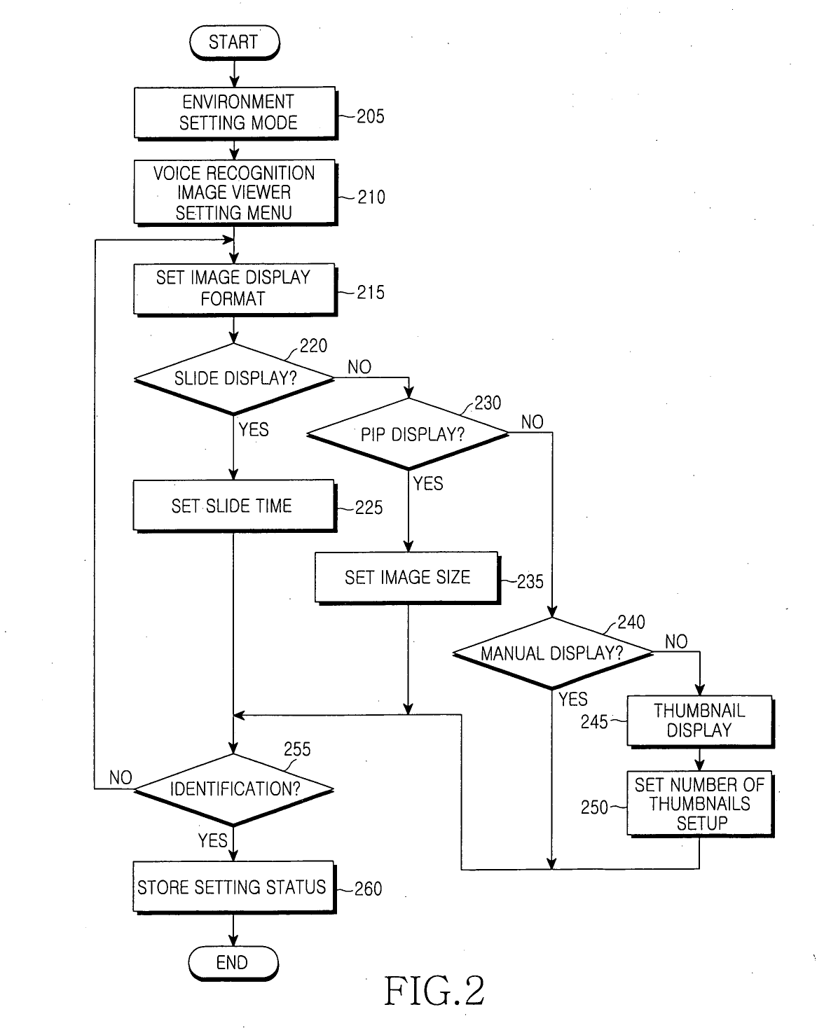

FIG. 2 is a flowchart illustrating an operation of setting an environment of a voice recognition image viewer according to an exemplary embodiment of the present invention. Referring to FIG. 2, the controller 100 operates in an environment setting mode in which an environment is set in accordance with various functional operations of the wireless terminal at step 205. The controller 100 displays a plurality of menus in accordance with the environment setting mode operation. The controller 100 receives input choosing a voice recognition image viewer setting menu from a user, the input chosen from among the displayed menus at step 210. In a case where the controller 100 will display an image corresponding to a voice input, as selected from among the voice recognition image viewer setting menus, the controller executes an image display format setting mode, in which setup for the display format of the image is received, at step 215.

The controller 100 may display a list of alternative image display formats, when the controller is in the setting mode. When an item in the displayed list is selected by the user, the controller 100 determines whether or not the selected item is a slide display format item at step 220. In a slide display format, images are sequentially displayed depending on time. In a case where the controller 100 determines that the selected item is a slide display format item, it receives a setup for a time regarding when the images are sequentially displayed at step 225. In a case where a plurality of images are displayed, the time may correlate to a time taken from when a first image is displayed until a second image is displayed.

In a case where the selected item is not a slide display format item at step 220, the controller 100 determines whether or not the selected item is a PIP display format item at step 230. In a case where the PIP display format item is selected as determined in step 230, the controller 100 sets the size of an image to be PIP displayed at step 235.

In a case where the PIP display format item is not selected as determined in step 230, the controller 100 determines whether or not the selected item is a manual display format item at a step 240. In a case where the controller 100 determines that the manual display format item is selected, it sets the display format as a format in which images are sequentially displayed depending on the user's key input.

In a case where the image display format is not set as the manual display format item as the result of step 240, the controller 100 sets the image display format as a thumbnail display format item at step 245. In a case where the image display format is set as the thumbnail display format item, the controller 100 receives setup for the number of thumbnails to be shown on the display 110 at step 250. Thereafter, the controller 100 determines if an identity has been input to identify that setup, in accordance with the display format set by the user, in step 255. The controller then stores the set image display format at step 260.

As described above, in an exemplary case where a voice is input from a user in an operation of setting an image display format using voice recognition, the controller 100 receives input regarding a setup for a format such as sequential display depending on time, PIP display, thumbnail display or sequential display depending on a key input so as to display a corresponding image from the memory 115.

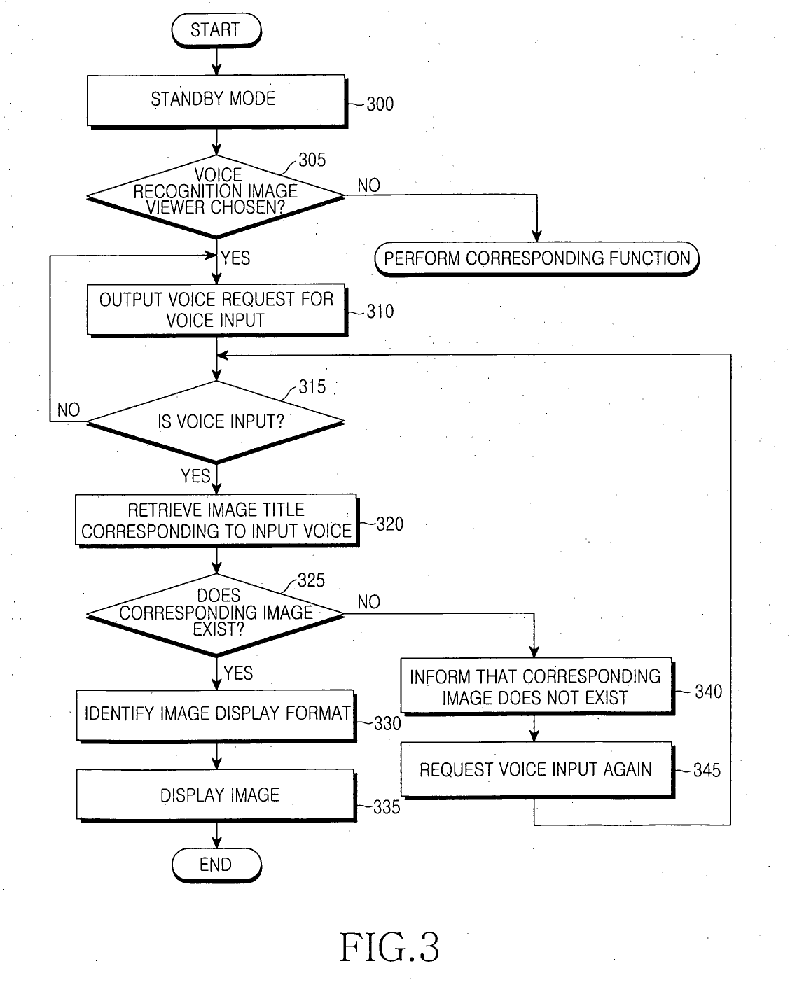

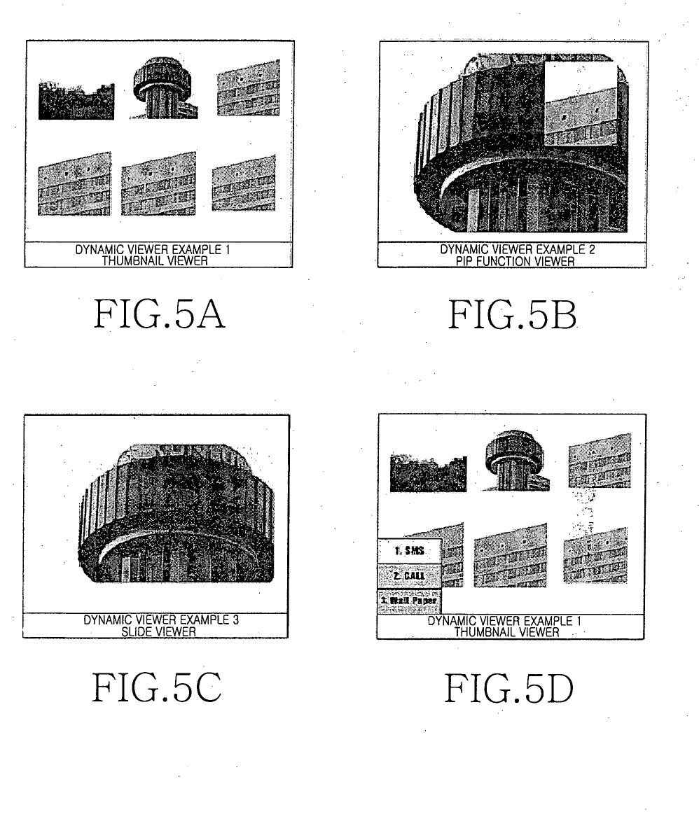

FIG. 3 is a flowchart illustrating an operation of displaying an image according to an exemplary embodiment of the present invention, and FIG. 5 is a view illustrating exemplary screens displayed according to an exemplary embodiment of the present invention. Referring to FIGS. 3 and 5, the controller 100 operates in a standby mode at step 300. In a case where the controller 100 senses a key input signal in the standby mode, it determines whether or not the sensed key signal is a key input for executing the voice recognition image viewer at a step 305. In an alternative exemplary embodiment of the present invention, the input may not be executed through a key input but through an input of a menu. Furthermore, the input execution may be additionally provided or executed depending on the number of input times of a camera mode execution key.

In the case where the controller 100 determines that the input key is a key through which a voice input mode for voice recognition image viewer execution is executed at step 305, it outputs a message requesting a voice input through a speaker connected to the audio processor 130 at step 310. The controller 100 determines whether or not a voice is input from a user through a microphone at step 315. Thereafter, the voice recognizer 135 compares the input voice with data registered in the database thereof and retrieves data with the highest similarity so as to output the corresponding data to the controller 100. The controller 100 retrieves filenames of images that have been previously stored in the memory 115 in accordance with the voice input from the voice recognizer 135 at step 320.

The controller 100 determines whether or not a filename of an image corresponding to the input voice exists in the memory 115 at step 325. In a case where the filename of the corresponding image does not exist, the controller 100 outputs a message informing that the corresponding image does not exist at step 340. Thereafter, the controller 100 requests voice input again, in accordance with the nonexistence of the image at step 345.

In a case where there exists an image corresponding to the voice input from the voice recognizer 135 as a result of step 325, the controller 100 identifies the image display format stored in the memory 115 in accordance with the setup for the display format described in FIG. 2 at step 330. The controller 100 displays images shown in the exemplary screens of FIG. 5 in accordance with the identification result at step 335.

An operation of displaying an image will be discussed with reference to FIG. 5. In the exemplary screen shown in FIG. 5A, in a case where the image display format is set as a thumbnail display item as an identification result of the image display format at the step 330, the controller 100 controls an image with a filename corresponding to a voice input from a user to be displayed in a thumbnail format. In the exemplary screen FIG. 5B, in a case where the image display format is set as a PIP display item as a result of an identification of the image display format at step 330, the controller 100 controls an image with a filename corresponding to a voice input from a user to be displayed in a PIP format. In the exemplary screen of FIG. 5C, in a case where the image display format is set as a slide display item or a manual display item, the controller 100 controls an image to be displayed in a slide display format or a manual display format. In a case where the image display format is set as the manual display item, the controller 100 displays an image as shown in the exemplary screen of FIG. 5C and then controls the next image to be displayed depending on user's key input. Further, in a case where the image display format is stet as the slide display item, the controller 100 displays an image as shown in the exemplary screen of FIG. 5C and then controls images to be sequentially displayed depending a preset time.

Thereafter, in a case where all the images corresponding to the input voice have been displayed, the controller 100 ends the voice recognition image viewer mode.

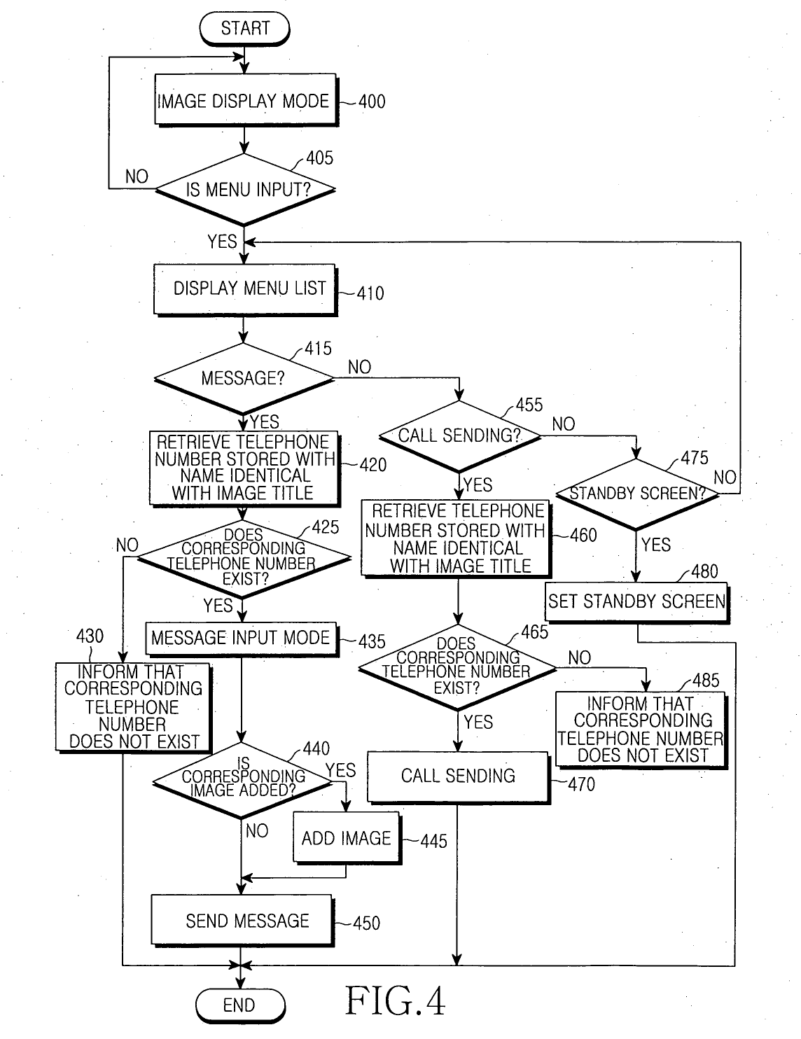

FIG. 4 is a flowchart illustrating the operation of executing a menu in the operation of displaying an image according to an exemplary embodiment of the present invention. Referring to FIG. 4, the controller 100 operates in an image display mode in which an image corresponding to the voice input from the user at step 335 of FIG. 3 is displayed in accordance with a preset format at step 400. In a case where the controller 100 senses a key signal in the image play mode, it determines whether or not the key signal is the menu key at step 405. In a case where the controller 100 determines that the input key is the menu key, it displays a menu list to overlap with the displayed image as shown in the exemplary screen 5D at step 410.

The controller 100 determines whether or not a message item is selected by the user from the displayed menu list at step 415. In a case where the selected item is a message as a determination result of step 415, the controller 100 retrieves a telephone number stored with the same name as the title of the displayed image in the memory 115 at a step 420. As a retrieval result of step 420, the controller 100 determines whether or not there exists a telephone number stored with the same name as the title of the image at a step 425. In a case where the corresponding number does not exist as a determination result of step 425, the controller 100 outputs a message informing the user that the telephone number does not exist at a step 430. On the other hand, in a case where the corresponding telephone number exists as a retrieval result of the step 420, the controller 100 converts the image display mode into a message input mode at step 435. After the message input mode has been executed, the controller 100 determines whether or not the displayed image is added in accordance with the image display mode so as to send a message at step 440. As a determination result of the step 440, the controller 100 sends the message at step 450 by adding the image at step 445 or by adding no image.

Meanwhile, in a case where the controller 100 determines that the message item is not selected in the displayed menu list at step 415, it determines whether or not a call sending is selected at step 455. In a case where the call sending is selected as a determination result of step 455, the controller 100 retrieves a telephone number stored with the same name as the title of the displayed image at a step 460, which is the same operation executed at step 420. Thereafter, the controller 100 determines whether or not the corresponding telephone number exists at step 465. In a case where the telephone number does not exist as a determination result of step 465, the controller 100 informs that the corresponding telephone number does not exist at step 485. On the other hand, in a case where the corresponding telephone number exists, the controller 100 executes a call mode in which a call is send to the corresponding telephone number at step 470.

In a case where the controller 100 determines that the selected menu is not a call sending menu as a result of step 455, it determines whether or not a standby screen item is selected at step 475. In a case where the controller 100 receives setup for a standby screen menu, it sets the displayed image as a standby screen at step 480. In a case where a plurality of images is displayed, at least one of the plurality of images is selected to be set as the standby screen.

As described above, while an image with a filename corresponding to a voice input from a user is displayed in a preset format, it is determined whether or not there exists a telephone number stored with the same name as the image in accordance with a menu selected from the user, and a menu such as call sending, message sending or standby screen setting is executed in a case where the corresponding telephone number exists.

As described above, according to the present invention, an image stored with a title corresponding to a voice input among images stored in a preset format is displayed using voice recognition in a wireless terminal so that a user can easily identify a desired image among the stored images. In a case where a menu is input when displaying an image, a call or message sending menu is executed to a telephone number stored with a name corresponding to the image so that a function of the wireless terminal can be easily executed.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for displaying an image in a wireless terminal, the method comprising:
receiving a voice input;
retrieving an image corresponding to the voice input and having a filename; and
displaying the retrieved image in a preset format.

2. The method as claimed in claim 1, wherein receiving a voice input comprises executing a voice recognition mode.

3. The method as claimed in claim 2, wherein executing the voice recognition mode comprises inputting at least one of a key input and a menu input.

4. The method as claimed in claim 1, wherein the preset format comprises at least one of a sequential display, a thumbnail display, and a Picture-In-Picture (PIP) display.

5. The method as claimed in claim 1, wherein the sequential display comprises at least one of an automatic sequential display with a time-delay between displayed images and a manual sequential display that displays images depending on a user's key input.

6. The method as claimed in claim 4, wherein displaying the retrieved image in a preset format comprises displaying the image, in a case where any one of images displayed in a thumbnail format is selected when the retrieved image is displayed in the thumbnail format, the selected image is enlarged and displayed.

7. The method as claimed in claim 1, further comprising:
determining if a menu for choosing functions of the wireless terminal is input when displaying the image;
displaying menu items including at least a call sending menu item and a message menu item;
retrieving a telephone number corresponding to the image if any of the menu items is selected; and
performing the selected function in accordance with the retrieval result.

8. The method as claimed in claim 7, wherein retrieving a telephone number comprises determining if a telephone number comprising the filename of the image exists in a phone book.

9. The method as claimed in claim 7, further comprising sending a message by adding the image thereto if the selected menu item is the message menu item.

10. A device for displaying an image in a wireless terminal, the device comprising:
a voice recognizer, for analyzing a voice input through a microphone and outputting associated data to a controller;
a memory, for storing at least one image and at least one image display format;
a display, for displaying at least one image stored in the memory in accordance with at least one display format; and
a controller, for retrieving at least one image stored with a filename corresponding to the voice analyzed by the voice recognizer and controlling the image to be displayed the at least one image display format.

11. The device as claimed in claim 10, wherein the memory stores a telephone number with a name comprising the filename of the image displayed.

12. The device as claimed in claim 10, wherein the display displays the image in a format comprising one of a sequential display, a thumbnail display, and a PIP (Picture-In-Picture) display and a sequential display depending on user's key input.

13. The device as claimed in claim 10, wherein the voice recognizer further includes a database having at least information on data input through the microphone and reference for similarity stored therein.

14. The device as claimed in claim 10, wherein the controller retrieves a telephone number with a name containing the filename of the image in the memory to execute a call sending or message menu to the telephone number.
